(19) United States
(12) Patent Application Publication
(10) Pub. No.: US 2010/0104684 A1
(43) Pub. Date: Apr. 29, 2010

(54) PRODUCTION MACHINE WITH MACHINE PANELLING

(76) Inventors: Dieter Jenzen, Uetersen (DE); Michael Litzenberg, Geesthacht (DE); Frank Lewin, Tangstedt (DE); Rolf Baumgarte, Ahrenburg (DE); Michael Linke, Hamburg (DE)

Correspondence Address: FRIEDRICH KUEFFNER, 317 MADISON AVENUE, SUITE 910, NEW YORK, NY, 10017, US

(21) Appl. No.: 12/450,248

(22) PCT Filed: Apr. 10, 2008
(86) PCT No.: PCT/DE2008/000664

§ 371 Date: Nov. 16, 2009

(30) Foreign Application Priority Data
May 25, 2007 (DE) 10 2007 024 560.4

(51) Int. Cl. B29C 49/00

(52) U.S. Cl. 425/526

(57) ABSTRACT

The production machine has functional elements which are arranged inside machine paneling (41). At least one access opening (42) which can be closed off by a positionable locking element (43), is arranged in the vicinity of machine paneling. The locking element is formed from a material which can be deflected while opening and closing movements are being carried out.

The invention concerns a production machine, which has functional elements arranged inside machine paneling, and in which the machine paneling has at least one access opening that can be closed by a positionable closing element.

Production machines of this type are available in various embodiments, including, for example, blow-molding machines, filling machines, or plasma coating installations. In production machines of this type, the machine paneling typically has access openings that can be closed by flaps or doors. The flaps or doors are often connected in a side region with the machine paneling by swivel joints. However, a system of this type often hinders an operator of the machine when, for example, the doors are opened to carry out service work or to eliminate disturbances.

In order to make available a larger free space to work in, it is also already known that flap-like closing elements can be connected in an upper region with the machine paneling by swivel joints, so that the flaps can be swiveled vertically upward. However, flaps of this type also have an adverse effect on the available work area. Moreover, when the flaps are swiveled upward, they are often positioned at head level for tall operating personnel and thus pose an accident risk.

In the case of production machines in the form of blow-molding machines, closing elements of this type are used both in the area of the blow-molding module and in the area of the heating module.

In container molding by the action of blowing pressure, preforms made of a thermoplastic material, for example, preforms made of PET (polyethylene terephthalate), are fed to different processing stations within a blow-molding machine. A blow-molding machine of this type typically has a heating system and a blowing system, in which the preform, which has first been brought to a desired temperature, is expanded by biaxial orientation to form a container. The expansion is effected by means of compressed air, which is fed into the preform to be expanded. DE-OS 43 40 291 explains the process-engineering sequence in this type of expansion of the preform. The aforementioned introduction of the pressurized gas comprises both the introduction of compressed gas into the developing container bubble and the introduction of compressed gas into the preform at the beginning of the blowing process.

The basic structure of a blowing station for container molding is described in DE-OS 42 12 583. Possible means of bringing the preform to the desired temperature are explained in DE-OS 23 52 926.

Various handling devices can be used to convey the preforms and the blow-molded containers within the blow-molding device. The use of transport mandrels, onto which the preforms are slipped, has proven especially effective. However, the preforms can also be handled with other supporting devices. Other available designs are grippers for handling the preforms and expanding mandrels, which can be inserted in the mouth region of the preform to support the preform.

The handling of containers with the use of transfer wheels is described, for example, in DE-OS 199 06 438 with the transfer wheel arranged between a blowing wheel and a delivery line.

The above-explained handling of the preforms occurs, for one thing, in so-called two-step processes, in which the preforms are first produced by injection molding and temporarily stored and then later conditioned with respect to their temperature and blown into containers. For another, the preforms can be handled in so-called one-step processes, in which the preforms are first produced by injection molding and allowed to solidify sufficiently and are then immediately suitably conditioned with respect to their temperature and then blow molded.

With respect to the blowing stations that are used, various embodiments are known. In the case of blowing stations that are arranged on rotating transport wheels, book-like opening of the mold supports is often encountered. However, it is also possible to use mold supports that can be moved relative to each other or that are supported in a different way. In stationary blowing stations, which are suitable especially for accommodating several cavities for container molding, plates arranged parallel to one another are typically used as mold supports.

In all previously known production machines and especially in the blow-molding machines described above, it has not yet been possible to satisfy the requirement of largely unhindered accessibility.

The objective of the present invention is to design a device of the aforementioned type in such a way that accessibility is improved.

In accordance with the objective, this objective is achieved by virtue of the fact that the closing element is made of a material that can be guided while opening and closing movements are being carried out.

The formation of the closing element from a material that can be guided is a simple means of helping to move the closing element away from the area of the access opening while an opening movement is being carried out. An embodiment that can withstand high mechanical stress can be provided by constructing the closing element from a plurality of slats that are connected with one another.

The slat-like construction of the closing element makes it possible to manipulate the closing element similarly to jalousies or folding doors. In a closed position, the individual slats essentially adjoin each other and are arranged in a plane, so that flat closure of the access opening is ensured. In an open position, the slats can be compactly arranged outside of the work area of a user. The opening and closing movements can be carried out manually, for example, with the use of a hand crank, or automatically, for example, with the use of an electric motor.

An embodiment that can withstand high mechanical stress can be provided by constructing the closing element from a plurality of slats that are movably connected with one another.

In accordance with one design variant, it is proposed that the longitudinal axes of the slats extend essentially vertically.

It is also possible for the longitudinal axes of the slats to extend essentially horizontally.

In the case of access openings in an upper region of the machine paneling, it has been found to be advantageous if the closing element is arranged in such a way that it can be positioned vertically in the area of the access opening.

In the case of door-like access openings, it is proposed that the closing element be arranged in such a way that it can be positioned horizontally in the area of the access opening.

Compact stowage of the closing element while carrying out an opening operation is possible if the closing element is arranged in such a way that it can be rolled up.

A relatively rigid embodiment of the closing element can be realized by arranging the closing element in such a way that it can be displaced by a guide element.

Another design variant consists in designing the closing element to be foldable.

In accordance with a typical embodiment, it is contemplated that the production machine will be realized as a blow-molding machine.

In particular, it is possible that the production machine will be realized as a blow-molding module of a blow-molding machine.

It is also contemplated that the production machine will be realized as a heating module of a blow-molding machine.

Visual functional monitoring of the functional elements of the production machine is assisted if at least a portion of the closing element is designed to be transparent.

Specific embodiments of the invention are illustrated in the accompanying schematic drawings.

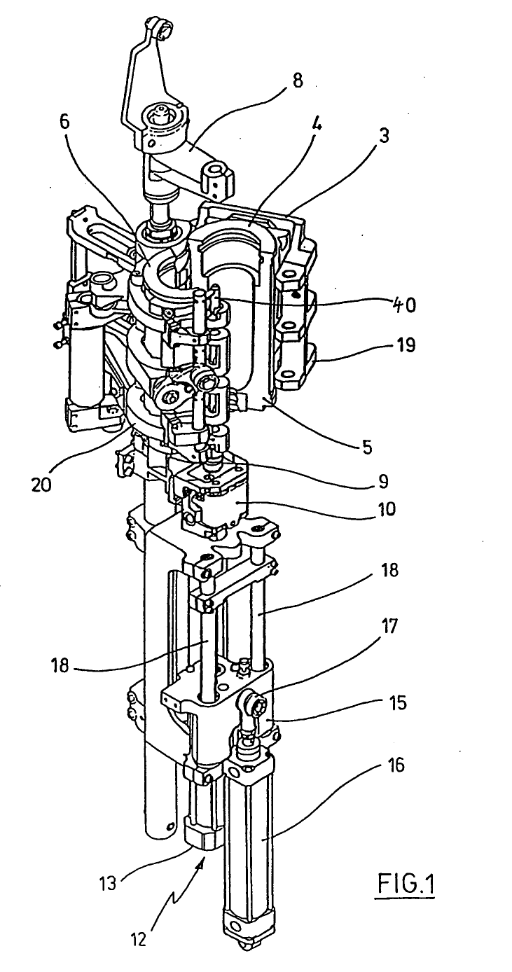

FIG. 1 shows a perspective view of a blowing station for producing containers from preforms.

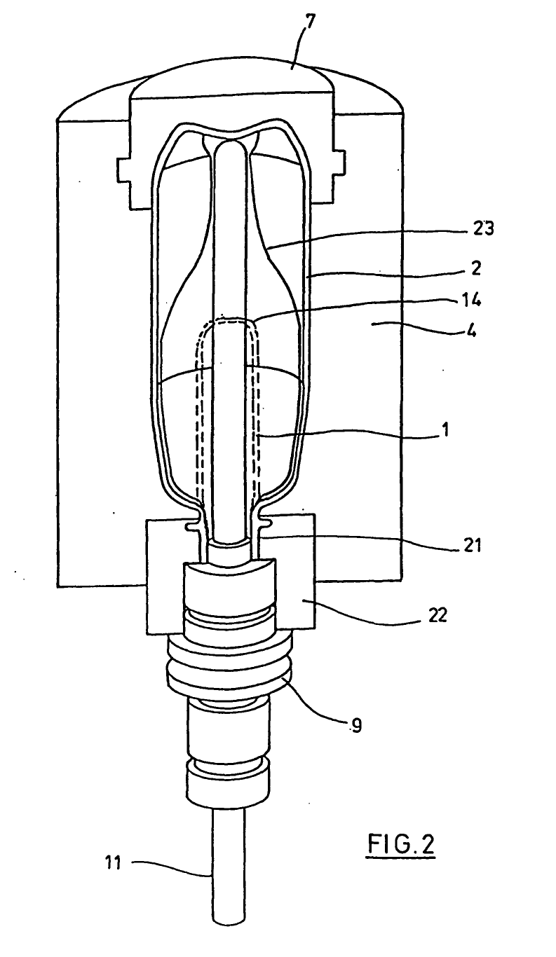

FIG. 2 shows a longitudinal section through a blow mold, in which a preform is stretched and expanded.

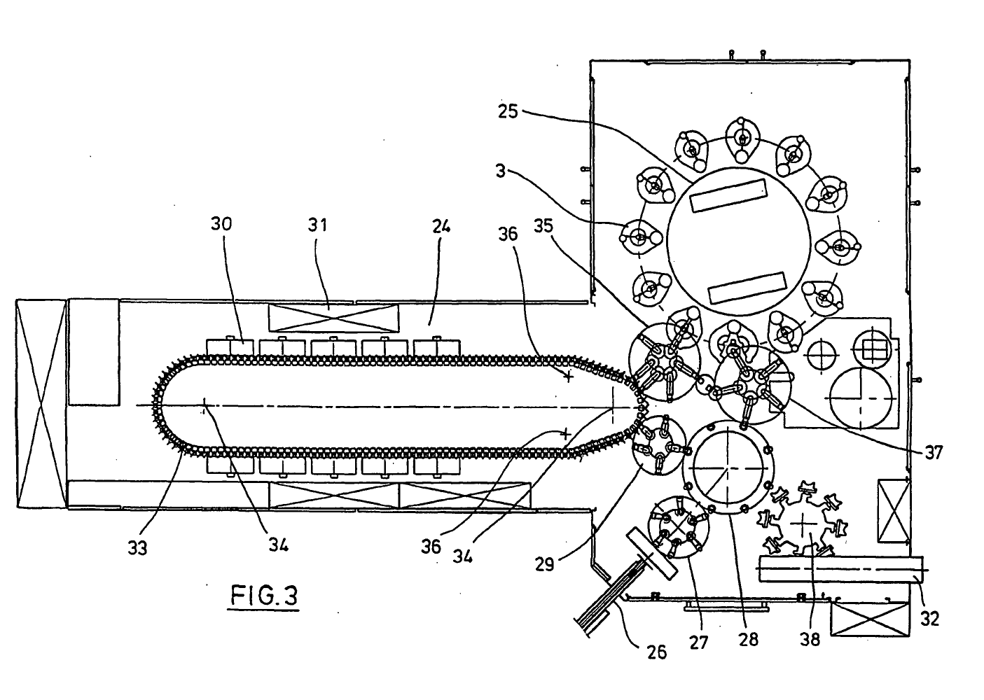

FIG. 3 is a drawing that illustrates a basic design of a device for blow molding containers.

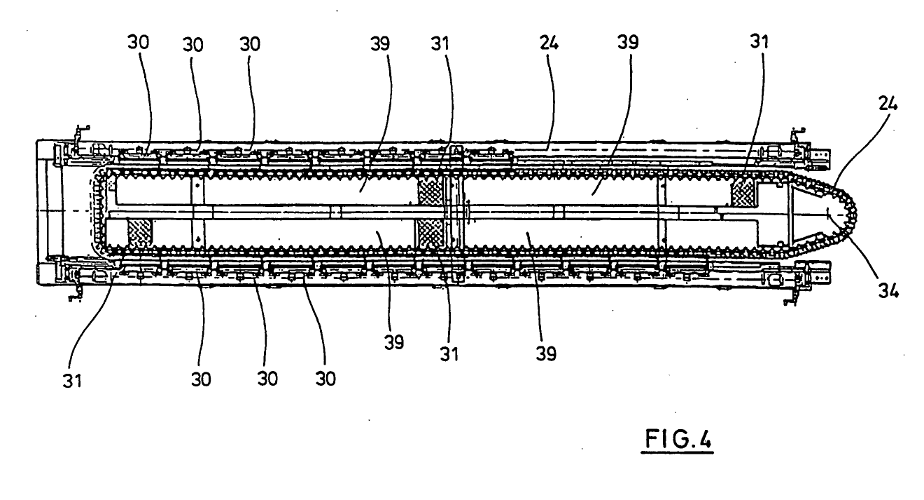

FIG. 4 shows a modified heating line with increased heating capacity.

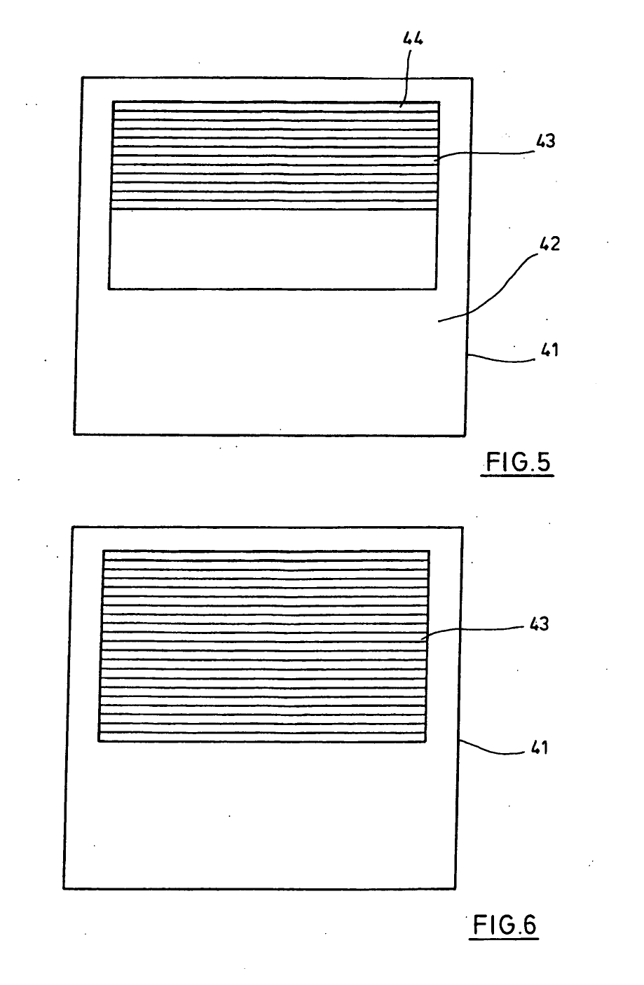

FIG. 5 shows a side view of a production machine with an access opening that is partially closed by a closing element.

FIG. 6 shows the arrangement according to FIG. 5 in a completely closed state of the access opening.

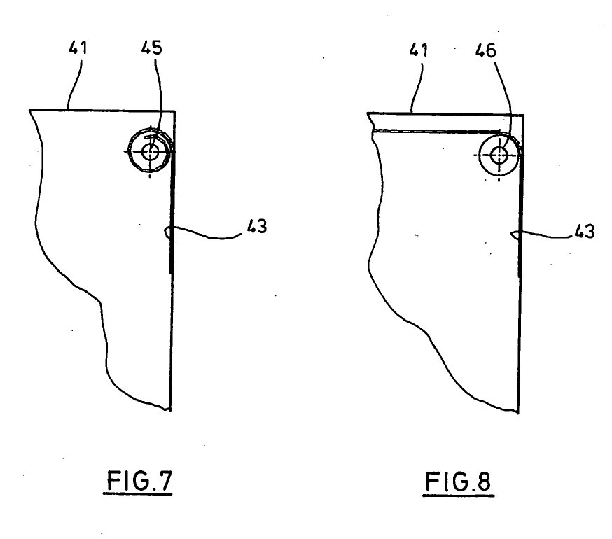

FIG. 7 shows a side view of a roll-up device for the slat-like closing element.

FIG. 8 shows a side view of a guide device for the slat-like closing element.

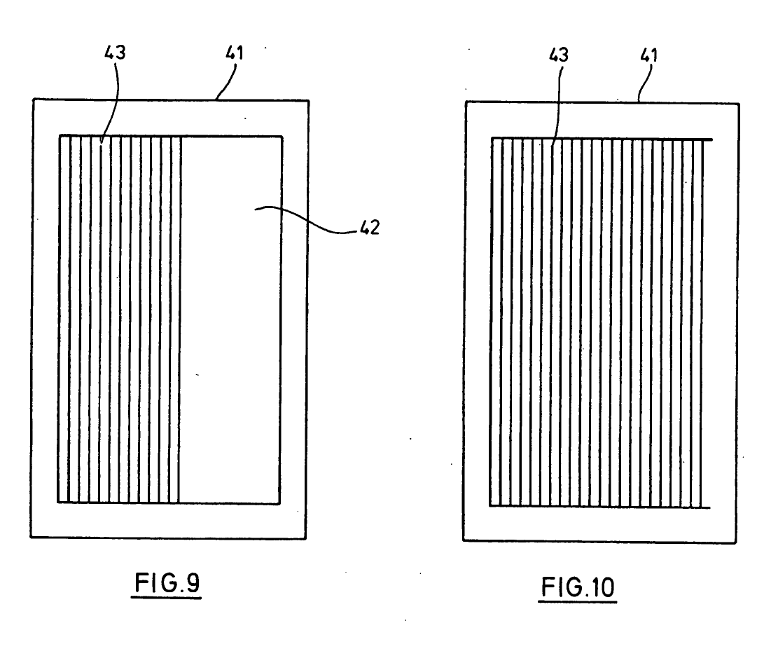

FIG. 9 shows a side view of a partially closed access opening, in which the closing element has vertically oriented slats.

FIG. 10 shows the arrangement according to FIG. 9 after the access opening has been completely closed.

FIG. 11 shows a partially closed access opening with a closing element, in which the slats are mounted in a way that allows them to fold.

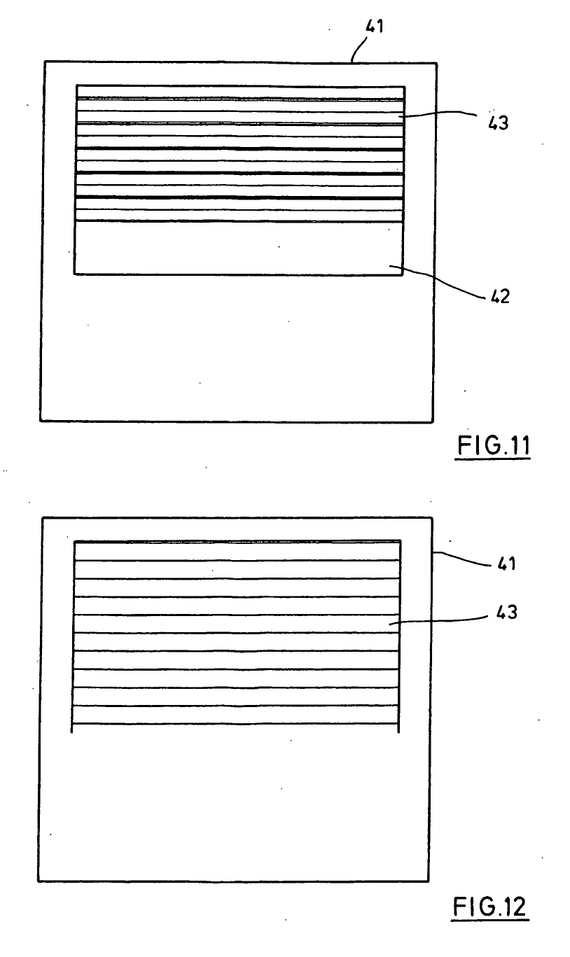

FIG. 12 shows the arrangement according to FIG. 11 after the access opening has been completely closed.

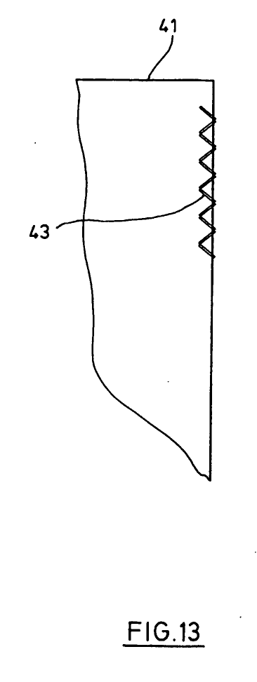

FIG. 13 shows a side view that illustrates a folding operation of the slat-like closing element.

FIGS. 1 and 2 show the basic design of a device for shaping preforms 1 into containers 2 as an example of a production machine.

The device for molding the container 2 consists essentially of a blowing station 3, which is provided with a blow mold 4, into which a preform 1 can be inserted. The preform 1 can be an injection-molded part made of polyethylene terephthalate. To allow a preform 1 to be inserted into the blow mold 4 and to allow the finished container 2 to be removed, the blow mold 4 consists of mold halves 5, 6 and a base part 7, which can be positioned by a lifting device 8. The preform 1 can be held in the area of the blowing station 3 by a transport mandrel 9, which, together with the preform 1, passes through a plurality of treatment stations within the device. However, it is also possible to insert the preform 1 directly into the blow mold 4, for example, with grippers or other handling devices.

To allow compressed air to be fed in, a connecting piston 10 is arranged below the transport mandrel 9. It supplies compressed air to the preform 1 and at the same time produces a seal relative to the transport mandrel 9. However, in a modified design, it is also basically possible to use stationary compressed air feed lines.

In this specific embodiment, the preform 1 is stretched by means of a stretch rod 11, which is positioned by a cylinder 12. However, in accordance with another embodiment, the stretch rod 11 is mechanically positioned by cam segments, which are acted upon by pickup rollers. The use of cam segments is advantageous especially when a large number of blowing stations 3 is arranged on a rotating blowing wheel.

In the embodiment illustrated in FIG. 1, the stretching system is designed in such a way that a tandem arrangement of two cylinders 12 is provided. Before the start of the actual stretching operation, the stretch rod 11 is first moved into the area of a base 14 of the preform 1 by a primary cylinder 13. During the stretching operation itself, the primary cylinder 13 with the stretch rod extended, together with a carriage 15 that carries the primary cylinder 13, is positioned by a secondary cylinder 16 or by a cam control mechanism. In particular, it is proposed that the secondary cylinder 16 be used in such a way under cam control that a current stretching position is predetermined by a guide roller 17, which slides along a cam track while the stretching operation is being carried out. The guide roller 17 is pressed against the guide track by the secondary cylinder 16. The carriage 15 slides along two guide elements 18.

After the mold halves 5, 6, which are arranged in the area of supports 19, 20, are closed, the supports 19, 20 are locked relative to each other by means of a locking mechanism 20.

To adapt to different shapes of a mouth section 21 of the preform 1, provision is made for the use of separate threaded inserts 22 in the area of the blow mold 4, as shown in FIG. 2.

In addition to the blow-molded container 2, FIG. 2 shows the preform 1, which is drawn with broken lines, and also shows schematically a container bubble 23 in the process of development.

FIG. 3 shows the basic design of a blow-molding machine, which has a heating line 24 and a rotating blowing wheel 25. Starting from a preform feeding device 26, the preforms 1 are conveyed to the area of the heating line 24 by transfer wheels 27, 28, 29. Radiant heaters 30 and fans 31 are arranged along the heating line 24 to bring the preforms 1 to the desired temperature. After sufficient heat treatment of the preforms 1, they are transferred to the blowing wheel 25, where the blowing stations 3 are located. The finished blow-molded containers 2 are fed to a delivery line 32 by additional transfer wheels.

To make it possible for a preform 1 to be formed into a container 2 in such a way that the container 2 has material properties that ensure a long shelf life of the foods, especially beverages, with which the container 2 is to be filled, specific process steps must be followed during the heating and orientation of the preforms 1. In addition, advantageous effects can be realized by following specific dimensioning specifications.

Various plastics can be used as the thermoplastic material, for example, PET, PEN or PP.

The preform 1 is expanded during the orientation process by feeding compressed air into it. The operation of supplying compressed air is divided into a preblowing phase, in which gas, for example, compressed air, is supplied at a low pressure level, and a subsequent main blowing phase, in which gas is supplied at a higher pressure level. During the preblowing phase, compressed air with a pressure in the range of 10 bars to 25 bars is typically used, and during the main blowing phase, compressed air with a pressure in the range of 25 bars to 40 bars is supplied.

FIG. 3 also shows that in the illustrated embodiment, the heating line 24 consists of a large number of revolving transport elements 33, which are strung together like a chain and are moved along by guide wheels 34. In particular, it is proposed that an essentially rectangular basic contour be set up by the chain-like arrangement. In the illustrated embodiment, a single, relatively large-sized guide wheel 34 is used in the area of the extension of the heating line 24 facing the transfer wheel 29 and a feed wheel 35, and two relatively small-sized guide wheels 36 are used in the area of adjacent deflections. In principle, however, any other types of guides are also conceivable.

To allow the closest possible arrangement of the transfer wheel 29 and the feed wheel 35 relative to each other, the illustrated arrangement is found to be especially effective, since three guide wheels 34, 36 are positioned in the area of the corresponding extension of the heating line 24, namely, the smaller guide wheels 36 in the area of the transition to the linear stretches of the heating line 24 and the larger guide wheel 34 in the immediate area of transfer to the transfer wheel 29 and to the feed wheel 35. As an alternative to the use of chain-like transport elements 33, it is also possible, for example, to use a rotating heating wheel.

After the blow molding of the containers 2 has been completed, the containers 2 are carried out of the area of the blowing stations 3 by an extraction wheel 37 and conveyed to the delivery line 32 by the transfer wheel 28 and a delivery wheel 38.

In the modified heating line 24 illustrated in FIG. 4, a larger number of preforms 1 can be heated per unit time due to the larger number of radiant heaters 30. The fans 31 in this case feed cooling air into the area of cooling air ducts 39, which lie opposite the associated radiant heaters 30 and deliver the cooling air through discharge ports. A direction of flow of the cooling air essentially transverse to the direction of conveyance of the preforms 1 is realized by the arrangement of the discharge directions. In the area of surfaces opposite the radiant heaters 30, the cooling air ducts 39 can provide reflectors for the thermal radiation. It is also possible to realize cooling of the radiant heaters 30 by the delivered cooling air.

FIG. 5 shows a side view of a production machine in the form of the blow-molding machine explained above. The production machine has machine paneling 41, which has at least one access opening 42. In the operating state illustrated in FIG. 5, the access opening 42 is partially closed by a closing element 43. The closing element 43 consists of a plurality of slats 44, which are movably connected with one another. In the embodiment illustrated here, the longitudinal axes of the slats 44 extend essentially in the horizontal direction and can be removed vertically from the area of the access opening 42.

As an alternative to the use of slats 44, it is also possible to produce the closing element 43 from a soft and flexible plate-like material.

FIG. 6 shows the arrangement according to FIG. 5 after the closing element 43 has been moved down completely to produce a completely closed state of the access opening 42.

FIG. 7 shows a side view of a roll-up device 45 for the closing element 43. The roll-up device can be designed for manual or motor-driven operation.

FIG. 8 shows an embodiment in which the closing element 43 is guided by a guide element 46. The closing element 43 can be moved into an open position with the use of the guide element 46. A guide for the closing element 43 can be installed behind the guide element 46 in a direction facing away from the access opening. It is also proposed that guides for the closing element 43 be arranged in a lateral region of the access opening 42. The guides can be designed, for example, as U-sections that extend essentially parallel to the direction of movement of the closing element 43.

FIG. 9 shows an access opening 42 in a partially closed state, in which the longitudinal axes of the slats 44 extend essentially in the vertical direction. FIG. 10 shows the access opening 42 in a completely closed state.

FIG. 11 shows an arrangement in which a closing element 43 with foldable slats is used. The access opening 42 is again partially closed here by the closing element 43. FIG. 12 shows the arrangement according to FIG. 11 with the access opening 42 in a completely closed state.

FIG. 13 is a side view that shows the slats 44 of the closing element 43 partially folded together. The slats 44 are folded together like an accordion. The slats 44 can be movably connected, for example, by joints. In particular, the use of film joints is also contemplated. For example, it is possible to realize the closing element 43 as a single part, wherein the slats 40 are realized as regions of thickened material, and the joints are realized as film-like regions of thinner material.

Plastic or metal, for example, can be used as the material for the slats 44. The use of glass is also contemplated.

The closing element 43 can be made opaque, transparent or tinted, according to requirements. When the closing element 43 is in a closed position, it can be locked, for example, by a lock.

1. A production machine, which has functional elements arranged inside machine paneling, and in which the machine paneling has at least one access opening that can be closed by a positionable closing element, wherein the closing element is made of a material that can be guided while opening and closing movements are being carried out.

2. A production machine in accordance with claim 1, wherein the closing element (43) consists of a plurality of slats (44) that are movably connected with one another.

3. A production machine in accordance with claim 2, wherein the longitudinal axes of the slats (44) extend essentially vertically.

4. A production machine in accordance with claim 2, wherein the longitudinal axes of the slats (44) extend essentially horizontally.

5. A production machine in accordance with claim 1, wherein the closing element (43) is arranged in such a way that it can be positioned vertically in the area of the access opening (42).

6. A production machine in accordance with claim 1, wherein the closing element (43) is arranged in such a way that it can be positioned horizontally in the area of the access opening (42).

7. A production machine in accordance with claim 1, wherein the closing element (43) is arranged in such a way that it can be rolled up.

8. A production machine in accordance with claim 1, wherein the closing element (43) is arranged in such a way that it can be displaced by a guide element (46).

9. A production machine in accordance with claim 1, wherein the closing element (43) is designed to be foldable.

10. A production machine in accordance with claim 1, wherein the production machine is realized as a blow-molding machine.

11. A production machine in accordance with claim 1, wherein the production machine is realized as a blow-molding module of a blow-molding machine.

12. A production machine in accordance with claim 1, wherein the production machine is realized as a heating module of a blow-molding machine.

13. A production machine in accordance with claim 1, wherein at least a portion of the closing element is designed to be transparent.
